(19) United States
(12) Patent Application Publication
(10) Pub. No.: US 2005/0111470 A1
(43) Pub. Date: May 26, 2005

(54) Method and apparatus for output rate control using time-sliced queues with signaling mechanism

(76) Inventors: Kazem Memarzadeh, Suwanee, GA (US); James A. Elsenbeck, Lilburn, GA (US); James E. Cannella, Roswell, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 10/720,304

(22) Filed: Nov. 24, 2003

(51) Int. Cl. H04L 12/56

(52) U.S. Cl. 370/412; 370/516

(57) ABSTRACT

A new time-sliced queue and signaling mechanism for implementing output rate control is described. The novel queue and the signaling mechanism are suitable for applications in which the output rate of elements of a large number of individual flows must be controlled independently. The method and apparatus including time-sliced output queues, examining the egress time of the elements of the flows, placing each element in one of the time slices of a time-sliced queue based on the egress time of the element, later removing each element from the queue at the appropriate egress time, sending out the element, and signaling the controlling process to place the next element for that flow in the time-sliced queue. If the egress times of two or more elements from different flows in the system fall within the same time slice in the queue, these elements are entered in the same time slice as a linked list of elements. A new element from each flow is placed in the time-sliced queue only after the controlling process is notified that the last element from the same flow has been removed from the time-sliced queue.

### FIELD OF THE INVENTION

This invention generally relates to the field of output rate control and more particularly to MPEG (Motions Pictures Experts Group) packet rate control and dejitter.

### DESCRIPTION OF THE RELATED ART

In many of today's video applications, video is typically digitized in real time and stored on digital media in the form of MPEG (Motions Pictures Experts Group) packets that are suitable for transporting from a source destination to a remote destination. In such video applications, a snapshot of the local clock associated with the video source equipment called a PCR (Program Clock Reference) is also periodically captured during the digitization process and included in the MPEG packets. These PCR values are later used to aid in recreating the video at the same exact rate that was produced at the video source.

In general, as MPEG video packets are transported through digital networks, the time spacing between MPEG packets is changed due to variable delays in the transport networks. This change in MPEG video packet timings is commonly referred to as packet jitter, and is described in detail in the ISO/IEC 13818-9 publication. At the end of the video transport network, this jitter must be removed by first determining the correct output time (egress time) for each MPEG packet using the PCR values and then outputting each packet at the precise egress time previously determined. Furthermore, because of the increasingly higher video bandwidth demands, today's video transport equipment should control the transmit rate of hundreds of individual MPEG video streams simultaneously in order to remove the aforementioned jitter. Since most equipment employs network processors in their designs, different software methods have been employed to implement a dejitter process. The effectiveness of the dejitter process and the maximum number of programs that can be handled by such systems are determined by two main factors: first, the accuracy with which the correct egress time for each packet can be determined; and second, the accuracy with which the exact actual output time of each packet matches its predetermined egress time.

In prior art techniques, such as rate cell or NCO (numerically controlled oscillator) approaches, the packet output time is controlled by using a counter to save the packet rate information for each MPEG program stream in the system. A software routine is then used to decrement and test the value of each counter periodically at a predetermined rate. Once the counter value reaches zero, the next packet from the MPEG stream associated with the counter is output, and the counter is reloaded with the next rate value. In this manner, the packets are sent out one after another each time the loaded counter value is decremented and reaches zero.

One obvious drawback of such prior art techniques is that as the number of MPEG program streams in a system increases, the loop time to sequentially decrement and test each counter value also increases. To that end, with the present state of the network processor speeds and the ever increasing demand for the number of MPEG program streams in a given system, the counter-based approaches of the prior art techniques fail to meet the bandwidth requirements of the systems needed for today's demanding applications. Hence, the present invention describes a novel approach that overcomes the abovementioned drawbacks of the prior art techniques.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 is a high-level block diagram of a non-limiting example of a video transport system in which packet dejitter may be employed in accordance with the present invention.

FIG. 2 is a block diagram representation of a conventional packet output rate control approach commonly referred to as rate-cell or NCO (numerically controlled oscillator) approach.

FIG. 3 depicts a block diagram of a preferred embodiment for precisely controlling the packet output rate and timing in accordance with the present invention.

FIG. 4 graphically illustrates a non-limiting example of a preferred structure for a time-sliced queue employed in the implementation of the present invention.

FIG. 5 shows a block diagram of a possible set of steps for determining the index into the time-sliced queue based on packet output or egress time.

FIG. 6 shows a non-limiting example of a flow diagram of a process that controls the packet output rate and timing in an MPEG video transport system that is suitable for use in implementing the present invention.

FIG. 7 illustrates a non-limiting example of a process for a time-sliced queue manager in accordance with the present invention.

### DETAILED DESCRIPTION OF THE PREFERRED EMBODIMENTS

Preferred embodiments of the invention can be understood in the context of a broadband communications system. Note, however, that the invention may be embodied in many different forms and should not be construed as limited to the embodiments set forth herein. All examples given herein, therefore, are intended to be non-limiting and are provided in order to help clarify the description of the invention.

The present invention is directed towards a method and apparatus that reduces packet jitter in a communications system. Transport equipment includes time-sliced queues for placing packets of a program stream received from a video source in accordance with the present invention. Accordingly, a packet processor controls the ingress and egress of the packets into and out of the time-sliced queues. Additionally, signaling mechanisms assist in the dejitter apparatus. Importantly, the apparatus reduces dejitter in the program stream, thereby equating a recreated stream at a receiving device with the program stream transmitted from the source.

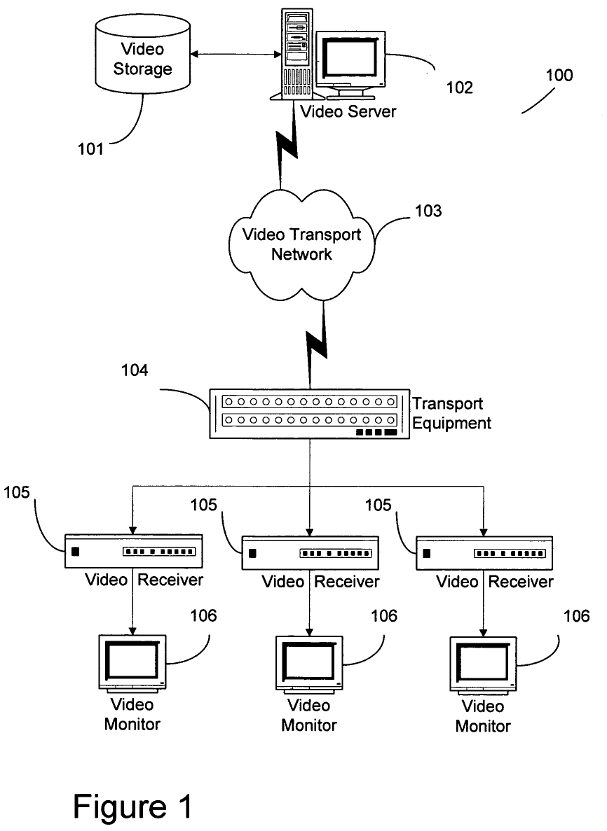

FIG. 1 is a high-level block diagram of a non-limiting example of a video transport system in which packet dejitter may be employed in accordance with the present invention. In a known manner, a video source in a video transport system 100 including a video server 102 retrieves signals, which may be video, audio, and/or data signals, from a storage device 101. The signals are then transmitted to a transport network 103 in the form of packets of MPEG-2 encoded data. The transport network 103 could be any suitable network, such as a cable or satellite television network or an Internet network, to name but a few. At the other end of the video transport network 103, transport equipment 104 receives the MPEG-2 packets, assembles them into new MPEG-2 video streams, and transmits the video streams to a plurality of video receivers 105. The video receivers 105 then transform the MPEG-2 streams into suitable forms, which can be displayed by a display device 106, such as a video monitor or a television.

In MPEG transport systems, in addition to the normal MPEG-2 encoded data, the video streams also contain special MPEG-2 PCR (program clock reference) packets that contain snapshots of a local clock associated with the video source. PCR values are used at the end of the transport network 103 to lock the video receivers' clock (not shown) to that of a video source clock (not shown). The locking of the clocks enables the video receivers, receiving the MPEG packets, to recreate the video at the same rate that it was generated at the video source. If the rate of the recreated video is different than the rate at which it was produced at the source, a buffer underflow or overflow in the video receivers 105 results.

Although the PCR values are crucial for locking of the clocks, the usefulness of the PCR values is highly dependent on their accuracy, which can be substantially degraded as the MPEG packets become jittered due to transport across digital networks with variable delays. Importantly, packet jitters that exceed the specifications, which can still be tolerated by the video receivers 105, could result in macro blocking and interruption or loss of video at the display device 106. Therefore, it is highly desirable to minimize the packet jitter as much as possible at the output of the transport equipment 104. Accordingly, one of the key functions of the transport equipment 104 is to dejitter the MPEG-2 packets before transmitting the packets to the video receivers 105. In accordance with the present invention, therefore, the dejitter process improves the accuracy of the PCR values embedded in the MPEG-2 PCR packets.

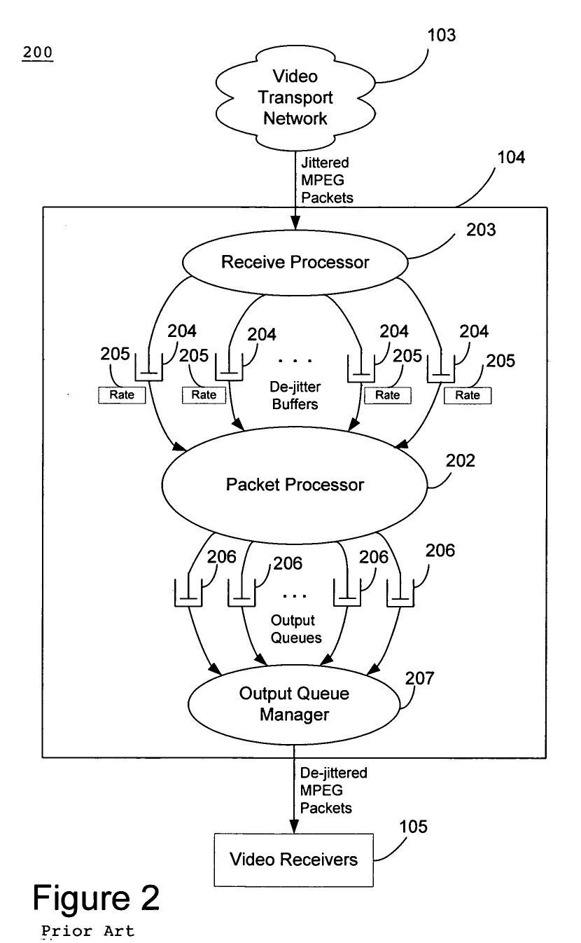

FIG. 2 is a block diagram representation of a conventional packet output rate control approach. The conventional approach (e.g., rate-cell and NCO approaches) are among the prior art techniques that are commonly used to control the timing of the MPEG packets at the output of video transport equipment, such as the transport equipment 104 considered herein. In general, the transport equipment 104 may include a receive processor 203 that is responsible for receiving the MPEG-2 packets from the transport network 103 via a suitable hardware interface (not shown). The receive processor 203 may then store the MPEG-2 packets in one of a plurality of temporary dejitter buffers 204, where each MPEG-2 packet is placed in one of the dejitter buffers 204 based on the MPEG-2 program to which it belongs. There is usually a one-to-one correspondence between each MPEG-2 program stream and each dejitter buffer 204. In addition, each dejitter buffer 204 is assigned a dedicated rate-cell, or counter 205, which is loaded with a proper value based on the egress time of the packet in its corresponding dejitter buffer 204. More specifically, for each dejitter buffer 204, a packet processor 202 examines the packets and their associated PCR values provided in the PCR packets in order to determine the packet rate and the necessary value that must be loaded in each rate cell 205. After a new value has been loaded into a rate cell 205, it is then periodically decremented at a predetermined clock tick until it reaches zero. At that point, the packet is removed from dejitter buffer 204 and placed in one of the output queues 206 so that it can be transmitted out by an output queue manager 207. Additionally, the function of the output queue manager 207 is to keep the output queues 206 empty by transmitting the packets as fast as possible. A round-robin method, among others, may be used, for example, to service each output queue 206. The rate cell 205 is then loaded with the proper value for the next packet and the process continues.

Therefore, as observed from the above description as the number of MPEG-2 programs in the system increases, the number of rate cell counters that should be periodically decremented and tested in a software loop increases. Since in today's video transport systems there are hundreds of program streams and the aggregate video bandwidth may exceed 1.0 Gbps (Giga bits per second), it is not practically possible to implement the aforementioned software loop for decrementing the rate cell counters considering the speed of the current state of the art network processors. As an alternate approach, therefore, the present invention is described next in full details. It will become apparent from the following description of the preferred embodiment of the present invention and the accompanying drawings that this invention contains certain novel features that overcome the shortcomings of the prior art technique described above.

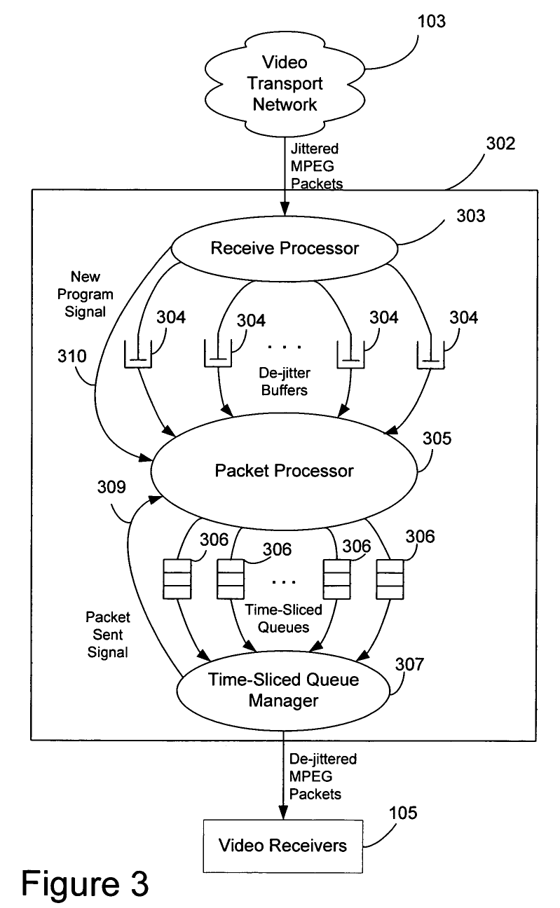

FIG. 3 illustrates a preferred embodiment of the invention that is suitable for use in novel transport equipment 302, which replaces the conventional transport equipment 104. One of the major differences between the new transport equipment 302 and the conventional transport equipment 104 is that the rate cell counters 205 have been eliminated and the output queues 206 have been replaced by new time-sliced queues 306 in accordance with the present invention. The overall operation begins when the receive processor 303 receives a packet included in a particular program stream. The processor 303 places a packet descriptor representing the packet (hereinafter referred to as “packet”) in a corresponding dejitter buffer 304 assigned to that program. If the packet is a first packet of a new program, the receive processor 303 also transmits a new program signal 310 to the packet processor 305. In this manner, the packet processor 305 is notified of new programs since the packet processor 305 does not routinely check the status of each dejitter buffer 304 in a loop. It will be appreciated that a routine check of the status of each dejitter buffer 304 is possible and within the scope of the present invention, but would be very time consuming and inefficient and is, therefore, avoided.

The packet processor 305 performs two key tasks in its normal execution loop. First, it checks for the new program signal 310 and, if a new program has been initiated, it begins the process for placing the first packet of the new program in an appropriate time-sliced queue 306. Second, the packet processor 305 receives a packet-sent signal 309 that is provided by a time-sliced queue manager 307. The packet-sent signal 309 informs the packet processor 305 when a packet has been removed from one of a plurality of time-sliced queues 306. The packet processor 305 will subsequently get a program identifier (ID) associated with the packet-sent signal 309 and attempt to remove the next packet of the same program from one of the dejitter buffers 304 and place it in the appropriate time-sliced queue 306. Therefore, once the first packet from a particular program is placed in a time-sliced queue 306, the packet-sent signal 309 triggers the processor 305 to send out all other packets belonging to the same program until there are no more packets for that program, i.e., the program has ended. Hence, the combination of the new program signal 310, the packet-sent signal 309, and the time-sliced queues 306 makes it possible to manage the flow of all the program streams present in the system 100 without the need for sequentially and unnecessarily checking the status of each dejitter buffer 304 or time-slice queue 306 in a round-robin or similar loops. With the above understanding of the overall operation of the invention, the individual components and processes of the invention are described next.

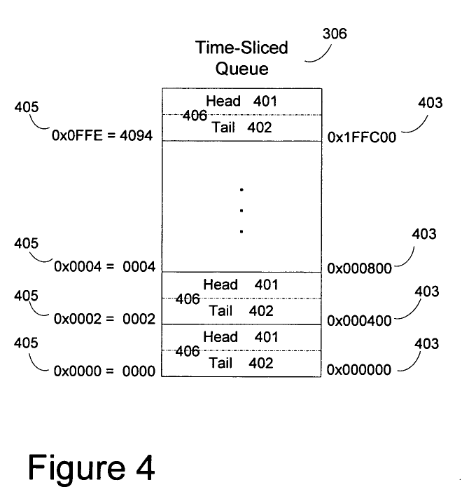

FIG. 4 graphically illustrates a non-limiting example of a preferred structure for the time-sliced queue 306 employed in the implementation of the present invention. Notably, the time-sliced queue 306 is divided into a fixed number of individual time slices 406. Numbers 403 on the right of the time-sliced queue 306 are times associated with each time slice 406 and are expressed in terms of the network processor's local clock ticks. Numbers 405 on the left are simply indices to the time slices 406 in the time-sliced queue 306. The “Ox” prefix in the numbers is used to indicate a hexadecimal representation. By way of example, the length in time for each time slice 406 can be computed by multiplying the size of the time slice 406 by a system clock tick value. In other words,

$$\begin{matrix}Time Slice Length = 0 x400 * ( 1 / 232.243 MHz ) \\ = 4.409 microseconds \\ Maximum Packet Rate = 1 packet / 4.409 microsecond \\ = 226 , 800 packets / second \\ Maximum Bit Rate = 226 , 800 packets * 188 bytes / packet * 8 bits / byte \\ = 341 Mega bits / seconds ,\end{matrix}$$

assuming a 232.243 MHZ (Mega Hertz) system clock. It shall be noted that in this particular non-limiting example, the length of all time slices 406 are equal. However, it is possible to adapt time slices 406 having varying time lengths without substantially departing from the operating principles of the invention.

Furthermore, each time slice 406 in the time-sliced queue 306 contains a head pointer 401 and a tail pointer 402. These pointers represent a linked list of one or more MPEG-2 packets scheduled to exit the time-sliced queue 306 during the specific time window associated with the time slice 406. In general, since an MPEG-2 Multi Program Transport Stream consists of many individual programs with independent timing requirements, it is possible that one or more packets from different programs may exit a time-sliced queue 306 within the same time window assigned to a time slice 406. Such packets are, therefore, linked together and entered in the same time slice 406 of the time-sliced queue 306 as a linked list. This is done based on a first-in-first-out basis and no sorting is performed at this level, in order to avoid time consuming sorting algorithms. Packets are added to the head of the linked list, and are removed from the tail of the linked list. Although, the linked list method has been chosen for this particular example of a preferred embodiment of the invention, it should be understood that the head and tail pointers 401, 402 or the linked list may be replaced with some other suitable packet entry structure, depending on the particular application without any substantial departure from the operating principles of this invention.

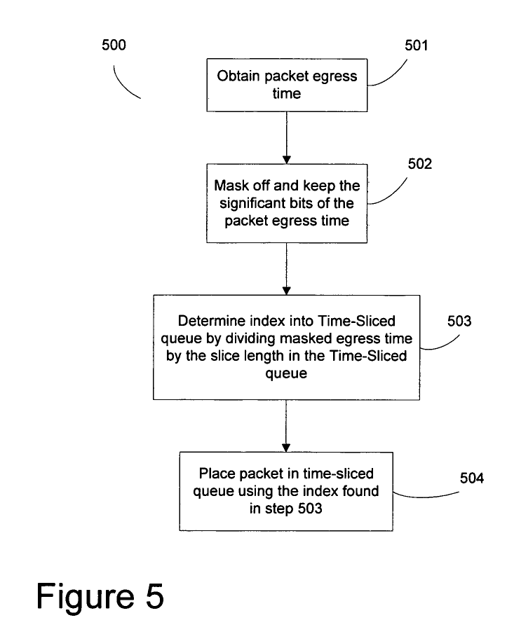

FIG. 5 shows a block diagram of a possible set of steps for determining an index into the time-sliced queue 306 based on packet output or egress time. With the above understanding of the structure of the time-sliced queues 306, a possible embodiment is described next that determines the placement, or index, of each packet in the time-sliced queues 306 based on the egress time of the packet. It should be noted that any method used for determining the optimum packet egress time has no impact to the operation of the present invention and, therefore, is not discussed. The example shows a block diagram representation that can be used to determine in which time slice 406 an MPEG-2 packet should be placed based on the computed egress time of the packet. In step 501, a predetermined packet egress time is obtained from memory. In step 502, significant bits of the packet egress time are kept by logically masking off the other bits. The significant bits of the egress time are dependent on the size of the time-sliced queue 306. In the example time-sliced queue 306 of FIG. 4, the overall size of the time-sliced queue 306 is 0x1 fffff. Therefore, only the first 21 rightmost bits of the egress time are significant. Next, in step 503, an index into the time-sliced queue 306 is found by dividing (shift right operation) the masked egress time by the length of the time slice 406. The MPEG-2 packet in step 504 is therefore placed in the time-sliced queue 306 based on the index found in step 503. This method of masking the significant bits and dividing by way of a shift operation has been chosen because the network processor, used in this example, does not include a division instruction. Other methods could be used with network processors that do support a division operation.

Referring again to FIG. 4, the above masking operation of the egress time results in a wrapping of the time-sliced queue 306 after every 0x200000 ticks of the system clock. The time resolution of each packet's egress time is also determined by the size of the individual time slices 406. The smaller the size of each time slice 406, the better the egress time resolution of the packet egress times. Also, increasing the number or size of the time slices 406 can increase the length of time the time-sliced queue 306 wraps around. In general, the optimum overall length of the time-sliced queue 306 and the size of the time slices 406 are highly system dependent, which should be selected based on the system packet rates and the desired resolution of the packet egress times. It will be appreciated that the above description explains how the time-sliced queues can be constructed and how the index for placing each packet in the time-sliced queue 306 may be computed from the packet egress time.

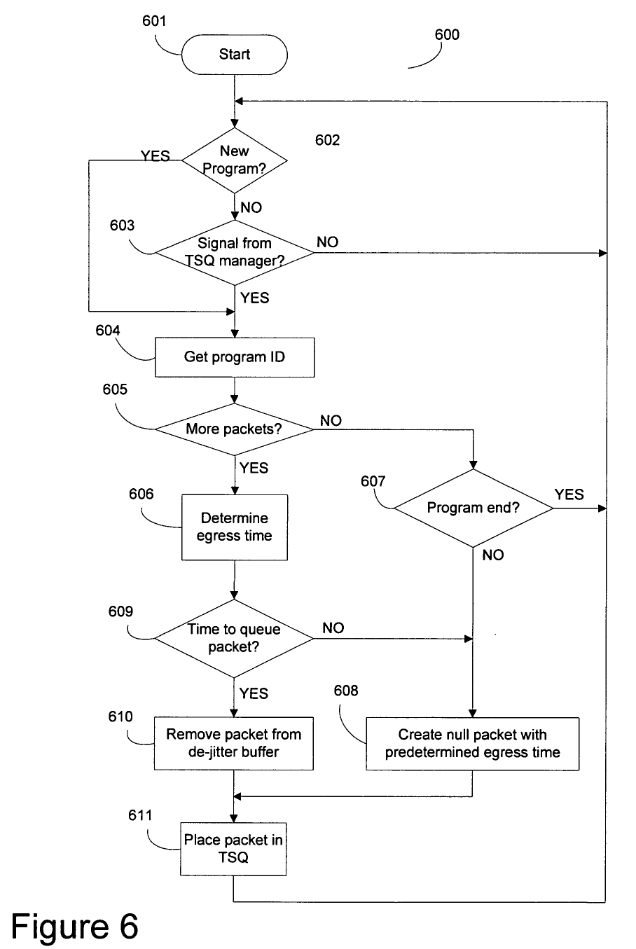

FIG. 6 shows a non-limiting example of a flow diagram of a process that controls the packet output rate and timing in an MPEG video transport system that is suitable for use in implementing the present invention. At the start of the process in step 601, the packet processor 305 first checks, in step 602, to see if there is a new program signal 310 from the receive processor 303 indicating that a new program has been activated. If a new program has been activated, the packet processor 305 obtains the ID of the new program in step 604. If there is no new program, the packet processor 305 moves from step 602 to step 603 and checks for the packet-sent signal 309 from the time-sliced queue manager 307 in order to determine if a packet has been removed from any of the time-sliced queues 306. If there is no signal, the packet processor will go back to step 602 to check for a new program again. If in step 603 there is a packet-sent signal 309 indicating that a packet has been removed from a time-sliced queue 306, the packet processor 305 moves to step 604 to obtain the program ID of the packet that was just removed from the time-sliced queue 306. Therefore, there are two ways for the packet processor 305 to reach to step 604: either the first packet of a new program has been received and placed in one of the dejitter buffers 304 or a packet from an existing program was just removed from a time-sliced queue 306. In either case, the process places a new packet of the same program in the appropriate time-sliced queue 306.

Once the program ID is obtained in step 604, the packet processor 305 checks in step 605 if at least one packet is available in the dejitter buffer 304 of the corresponding program. If there are no more packets, then the packet processor moves to step 607 to determine whether or not the corresponding program has ended. If the program has ended, then no further processing is necessary and the packet processor 305 returns to step 602. If the program is still active but there are no more packets currently available in the corresponding dejitter buffer 304 due to a temporary interruption in the program flow, for example, then the program is kept active. This is accomplished by creating a special packet, hereinafter called a null packet, in step 608, that contains the normal program information but no MPEG-2 data. The packet processor 305 then proceeds to step 611 to place the null packet in the corresponding time-sliced queue 306 based on the egress time of the null packet. Without placing this null packet in the time-sliced queue 306, the program would be terminated since there would be no more signals from the time-sliced queue manager 307 to initiate the transfer of the next packet of the program when it does eventually become available. Placing the null packet in the time-sliced queue 306 then generates a signal from the time-sliced queue manager 307 when the null packet is removed from the time-sliced queue 306 at the null packet's egress time. At that time the status of the corresponding program's dejitter buffer 304 may be checked again for any new packets.

It should be noted that the null packet is removed from a time-sliced queue 306 when the current time matches the null packet's egress time, but the packet is not actually transmitted out. Instead, only a signal is sent to the packet processor 305 indicating that the null packet was removed from the time-sliced queue 306, and the next packet of the corresponding program may be placed in the time-sliced queue 306. Furthermore, the egress time of null packets should be chosen based on the packet rate of the corresponding program, the size of the dejitter buffers 304, and the size of the corresponding time-sliced queue 306. In the particular example of the preferred embodiment, the egress time of the null packets are determined by dividing the overall length (in time) of the corresponding time-sliced queue by 4, and then adding that value to the current system time. This ensures that the computed egress time will fall within the time-sliced queue 306 without any wrap-around and that it is placed far enough in the future time that the frequency of the null packets will not overwhelm the packet processor 305 or the time-sliced queue manager 307.

Returning to step 605, if at least one more packet exists in the corresponding dejitter buffer 304 of the program being processed, then the packet processor 305 moves to step 606 to determine the egress time for the current packet. As mentioned earlier, the method by which the egress time is determined is system dependent and does not alter the method of this invention in any way. After the desirable egress time is determined in step 606, the packet processor 305 proceeds to step 609 to determine whether or not based on the current system time and the packet egress time it is possible to place the packet in the time-sliced queue 306 without a complete wrap-around. In general, if the difference between the packet egress time and the current time is greater than the length of the corresponding time-sliced queue 306, then the packet cannot be placed in the time-sliced queue 306 without a complete wrap-around. In that case, the packet processor 305 moves to step 608 to create a null packet to place in the corresponding time-sliced queue 306 instead of the real packet. The null packet will ensure that the packet signal 309 is generated later for the same program, at which time the egress time of the present packet may be checked again.

If, in step 609, it is determined that it is time to place the packet in the time-sliced queue 306, the packet processor 305 then advances to step 610 where the packet is removed from the corresponding dejitter buffer. Finally, the packet processor 305 places the packet in its corresponding time-sliced queue 306 based on its egress time, using the steps described in process 500 of FIG. 5. The packet processor 305 then moves to step 602 at the beginning of process 600 to check for and process the next packet of the next program.

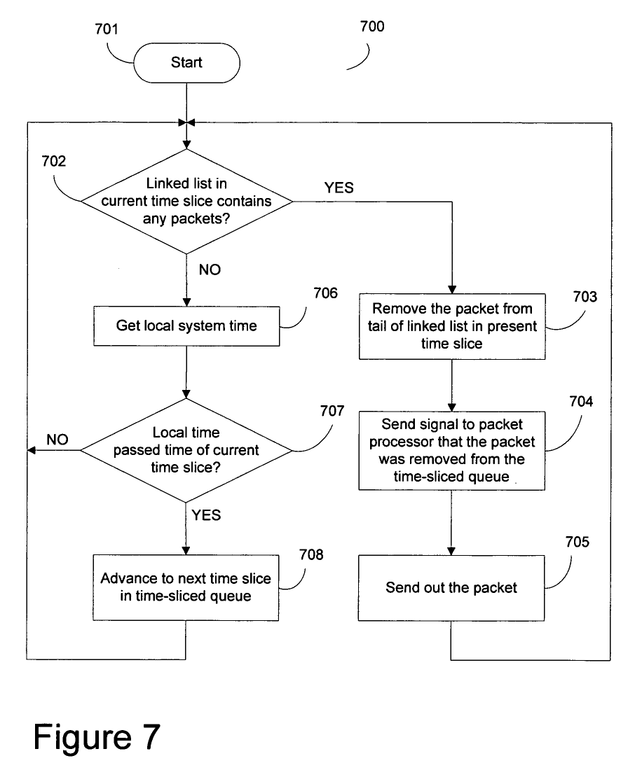

FIG. 7 illustrates a non-limiting example of a process for the time-sliced queue manager 307 in accordance with the present invention. The process 700 begins in step 701. In step 702, the time-sliced queue manager 307 checks the head and tail pointers 401, 402 of the current time slice 406 in the time-sliced queue 306. If in step 702 it is determined that the linked list contains at least one packet, the time-sliced queue manager 307 moves to step 703 and removes the next packet from the tail of the linked list and adjusts the tail pointer 402 accordingly. Next, the time-sliced queue manager 307 advances to step 704 where a signal 309 is sent to packet processor 305 indicating that a packet was just removed from the time-sliced queue 306 and is being transmitted out. The signaling mechanism also includes information about the ID of the program to which the packet belongs. The time-sliced queue manger 307 then moves to step 705 and sends out the removed packet and proceeds to the beginning of the process 700 at step 702. If it is determined in step 702 that the current time slice 406 contains no packets, then the time-sliced queue manger 307 moves to step 706 to get the current system time and next to step 707 to determine if it is time to advance to the next time slice 406 in the time-sliced queue 306. In step 707, if it is determined that the current system time has passed the time of current time slice 406, then time-sliced queue manager 307 proceeds to step 708, which advances to the next time slice 406 in the time-sliced queue 306, and subsequently returns to step 702.

The illustrations in FIGS. 3-7 represent modules, segments, or portions of code that can be implemented in a hardware (e.g., Application Specific Integrated Circuits or Field Programmable Gate Arrays) or software routines executing on a microcomputer, microprocessor, or a network processor. Each implementation may have a perceived advantage based on the particular application in which it is used. For instance, the hardware implementation may be faster and least expensive in large quantities, whereas the software implementation may result in shorter design times and provide more flexibility for adapting to requirement or feature changes.

Hence, the embodiments of the present invention that are described above, in particular any “preferred embodiments,” are merely possible examples, among others, of the implementations employed herein to aid in a clear understanding of the principles of the present invention. Many variations and modifications may be made to the embodiments of the invention described above without substantially departing from the principles of the invention. All such modifications and variations are intended to be included herein within the scope of the present invention disclosure and are protected by the following claims.

1. An apparatus for receiving a plurality of packets from a video source and for transmitting the plurality of packets to receiving devices, the plurality of packets is associated with one of a plurality of programs, the apparatus for controlling an output rate of the plurality of packets, the apparatus comprising:
a receive processor for receiving the plurality of packets, wherein each packet has a packet identifier;
buffers for receiving and buffering the plurality of packets, wherein each packet is provided to one of the buffers according to a specific program;
a packet processor for retrieving each buffered packet from the buffers;
time-sliced queues for queuing the retrieved packet, wherein each retrieved packet is provided to one of the time-sliced queues according to the specific program; and
a queue manager for controlling the output of each packet from the time-sliced queues depending upon its egress time, and for providing the packets to the receiving devices,
wherein the queue manager, upon removing a packet from one of the time-sliced queues, notifies the packet processor to retrieve and place a next packet having a common program identifier as the removed packet.

2. The apparatus of claim 1, wherein the packet processor receives the program identifier of the removed packet and searches the buffers for a buffered packet having the common program identifier.

3. The apparatus of claim 1, wherein when the receive processor receives a packet having a new program identifier that is indicative of a new program, the receive processor provides a new-program signal to the packet processor.

4. The apparatus of claim 1, wherein the packet processor retrieves the egress time associated with each packet, and wherein, depending upon the egress time, places the packet into an index in one of the time-sliced queue.

5. The apparatus of claim 4, wherein a null packet is used to maintain flow of each program when there are no packets available in the buffers for that program.

6. A method for controlling an output rate of a plurality of jittered packets in a data stream, the method comprising the steps of:
buffering the plurality of jittered packets, each jittered packet buffered in one of a plurality of buffers according to a specific program;
retrieving each buffered packet from the plurality of buffers depending upon a program identifier identifying the specific program;
queuing the retrieved packets in one of a plurality of time-sliced queues according to the specific program;
removing the queued packets according to an output time associated with the packets and the program identifier,
wherein upon removing a packet, providing a packet-sent signal in order to retrieve a next buffered packet having a common program identifier with the removed packet.

7. The method of claim 6, the steps further comprising:
determining an index into one of the time-sliced queues based on the output time; and
placing a packet descriptor that is indicative of the buffered packet into the determined index.

8. A method for controlling an output time and rate of data packets, the data packets belonging to a plurality of digital data streams in a digital transport system, the method comprising the steps of:
retrieving an appropriate output time for each data packet;
determining an index into one of a plurality of time-sliced queues based on the data packet output time;
placing a packet descriptor that is indicative of the data packet in one of the time-sliced queues based on the index;
removing the packet descriptor from one of the time-sliced queues during a time that matches a time slice in the time-sliced queue in which the packet descriptor was placed; and
transmitting the data packet.

9. The method of claim 8, wherein a new-stream signal is used to trigger a beginning packet flow for a particular stream.

10. The method of claim 8, wherein a packet-sent signal is used to trigger placing a next packet in one of the plurality of time-sliced queues for a particular stream.

11. The method of claim 10, wherein a special null packet is used to maintain flow of a stream during times when no data packets are available in a buffer for that particular stream.

12. The method of claim 8, wherein the data packets are one of an MPEG encoded video, audio, and data packets.
